(19) United States
(12) Patent Application Publication
(10) Pub. No.: US 2003/0170555 A1
(43) Pub. Date: Sep. 11, 2003

(54) Positively-charged electrophotographic organophotoreceptor, and cartridge, drum and image forming apparatus having same

(75) Inventors: Nam-Jeong Lee, Seoul (KR); Hwan-Koo Lee, Gyeonggi-do (KR); Saburo Yokota, Gyeonggi-do (KR); Kyung-Yol Yon, Gyeonggi-do (KR); Hae-Ree Joo, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd, Suwon-City (KR)

(21) Appl. No.: 10/351,375

(22) Filed: Jan. 27, 2003

(30) Foreign Application Priority Data
Mar. 7, 2002 (KR) 2002-12154

(51) Int. Cl. G03G 5/047

(52) U.S. Cl. 430/59.5; 430/78; 430/96; 430/56; 430/59.4; 430/133; 399/159

(57) ABSTRACT

A composition for a charge generating layer of a positively-charged electrophotographic organophotoreceptor and the positively-charged electrophotographic organophotoreceptor having a charge generating layer formed using the composition are utilized in a photocopy apparatus/organophotoreceptor drum/organophotoreceptor cartridge and a method of manufacturing the positively-charged electrophotographic organophotoreceptor. The charge generating layer composition for the positively-charged electrophotographic organophotoreceptor, which has a charge transport layer and a charge generating layer sequentially coated on a conductive support, includes a charge generating material, a binder, and an organic solvent containing an alcoholic solvent and an acetate solvent in a ratio from 1:9 to 5:5 by weight.

### CROSS-REFERENCE TO RELATED APPLICATIONS

This application claims the benefit of Korean Patent Application No. 2002-12154, filed Mar. 7, 2002, in the Korean Intellectual Property Office, the disclosure of which is incorporated herein by reference.

### BACKGROUND OF THE INVENTION

1. Field of the Invention

The present invention relates to a positively-charged electrophotographic organophotoreceptor, and more particularly, to a composition for a charge generating layer of a positively-charged electrophotographic organophotoreceptor, capable of preventing damage to a charge transport layer formed below the charge generating layer, and a dual-layered organophotoreceptor having a charge generating layer formed of the above composition.

2. Description of the Related Art

A dual-layered, positively-charged organophotoreceptor for use in electrophotography includes a charge transport layer and a charge generating layer sequentially coated on a conductive support. In general, the charge generating layer is so thin that it easily wears due to friction against toner or a cleaning blade. For this reason, a protective overcoat layer is coated on the charge generating layer.

The principles of charging and exposing the surface of the organophotoreceptor having the above basic structure and electrophotographically forming an image using toner will be described briefly.

When the surface of the organophotoreceptor is positively charged and irradiated with a laser beam, positive and negative charges are generated in the charge generating layer. Positive charges are injected into the charge transport layer and then into the conductive support by applying an electric field. Negative charges (electrons) in the charge generating layer migrate to the surface of the overcoat layer and neutralize the surface charge of the overcoat layer. As a result, the surface potential in an exposed area is changed so that a latent image is formed. As the latent image is developed with toner, a visible image is formed on the surface of the organophotoreceptor and transferred to the surface of a receiver, such as paper or a transfer receptor.

In the dual-layered positively-charged electrophotographic organophotoreceptor as described above, since the charge transport layer and the charge generating layer are separately formed having different functions, it is easy to control the photoelectric properties of the photoreceptor, such as a charging potential and an exposure potential, compared to a single-layered organophotoreceptor where the photoelectric requirements should be satisfied only by the single layer. In particular, although the photoreceptor layer of the dual-layered organophotoreceptor is thin, and an electric field is applied stably, it can hold large charges. Accordingly, more toner particles can be applied during development.

However, as a composition for the charge generating layer is coated on the charge transport layer in the manufacture of the dual-layered positively-charged electrophotographic organophotoreceptor, the organic solvent contained in the charge generating layer composition dissolves part of the underlying charge transport layer, thereby changing the thickness of the charge transport layer. As the material of the charge transport layer dissolves, the ability to transport charges degrades. Also, the charge generating layer coating solution is contaminated by dissolving the charge transport layer composition.

To eliminate these problems, the use of organic solvents that do not dissolve the material of the charge transport layer in the preparation of the charge generating layer composition has been suggested. However, in this case, an interface is well-defined between the charge transport layer and the charge generating layer, so charges generated in the charge generating layer by laser irradiation cannot be injected into the charge transport layer. As a result, the surface potential in an exposed area is relatively high, and the exposure potential becomes higher with repeated use.

### SUMMARY OF THE INVENTION

Accordingly, the invention includes a composition for a charge generating layer for a positively-charged electrophotographic organophotoreceptor that facilitates injection of charges from the charge generating layer to the charge transport layer, and has improved exposure potential properties.

The invention also provides a positively-charged electrophotographic organophotoreceptor having a charge generating layer having the above composition and a method of manufacturing the organophotoreceptor. In the positively-charged electrophotographic organophotoreceptor, the surface potential in an exposed area, i.e., the exposure potential, is lowered, and the development performance when using liquid toner is improved.

Additional aspects and advantages of the present invention will be set forth in part in the description which follows and, in part, will be obvious from the description, or may be learned by practice of the invention.

In one aspect, the present invention provides a composition for a charge generating layer of an electrophotographic, positively-charged organophotoreceptor in which a charge transport layer and the charge generating layer are sequentially coated on a conductive support, the composition comprising: a charge generating material; a binder; and an organic solvent containing an alcoholic solvent and an acetate solvent in a ratio from 1:9 to 5:5 by weight.

In another aspect, the present invention provides a positively-charged electrophotographic organophotoreceptor comprising a conductive support; a charge transport layer formed on the conductive support; and a charge generating layer formed by coating the charge generating layer composition described above on the the charge transport layer and drying the coated charge generating layer composition.

In another aspect, the present invention provides a method of manufacturing the positively-charged electrophotographic organophotoreceptor described above, the method involving: forming a charge transport layer on a conductive support; dissolving a binder in an organic solvent selected from the group consisting of an alcoholic solvent, an acetate solvent, and a mixture of the foregoing solvents, followed by the addition of a charge generating material, milling, dilution of the milled product with an alcoholic solvent, an acetate solvent, or a mixture of the alcoholic and acetate solvents, and mixing, to form a charge generating layer composition; and coating the charge generating layer composition on the charge transport layer and drying the coated charge generating layer composition to form a charge generating layer.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A positively-charged electrophotographic organophotoreceptor according to an embodiment of the present invention has a structure in which a charge transport layer and a charge generating layer are sequentially stacked on a conductive support. A composition for the charge generating layer according to the present invention includes a charge generating material, a binder, and an organic solvent. The organic solvent is composed of an alcoholic solvent and an acetate solvent. Examples of the alcoholic solvent include ethanol, isopropyl alcohol, n-butanol, methanol, 1-methoxy-2-propanol, diacetone alcohol, isobutyl alcohol, t-butyl alcohol, and a mixture of the foregoing alcohols. Examples of the acetate solvent include ethyl acetate, butyl acetate, isopropyl acetate, isobutyl acetate, sec-butyl acetate, and a mixture of the forgoing acetates. It is preferable that the amount of the organic solvent be in the range of about 90-99% by weight based on the weight of the charge generating layer composition. It is preferable that the alcoholic solvent and the acetate solvent be mixed in a ratio from 1:9 to 5:5. If the amount of the organic solvent is less than 90% by weight, a thick charge generating layer results, and the electrophotographic properties of the photoreceptor, for example, an increase in dark decay, degrade. If the amount of the organic solvent exceeds 99% by weight, the resulting charge generating layer is so thin that the quantity of charges generated by laser beam irradiation is small, and the exposure potential in the exposed area increases. If the ratio of the alcoholic solvent to the acetate solvent is less than the above range, the charge generating layer composition dissolves the constituents of the charge transport layer and cannot be coated on the charge transport layer. If the ratio of the alcoholic solvent to the acetate solvent exceeds the above range, the interface between the charge transport layer and the charge generating layer is well-defined, and charges cannot be injected from the charge generating layer into the charge transport layer, increasing the exposure potential.

In the charge generating layer composition according to the present invention, the charge generating material is a compound which is capable of absorbing light to generate charge carriers, such as a dye or a pigment. Examples of the charge generating material include metal-free phthalocyanine (e.g., PROGEN 1 x-form metal-free phthalocyanine from ZENECA INC.) and metal phthalocyanine, such as titanium phthalocyanine, copper phthalocyanine, titanyloxy phthalocyanine or hydroxygallium phthalocyanine, with titanyloxy phthalocyanine being more preferred in the present invention. The binder is capable of dispersing or dissolving the charge generating material. Examples of the binder include polyvinyl butyral, polycarbonate, polyvinyl alcohol, polystyrene-co-butadiene, a modified acrylic polymer, polyvinyl acetate, a styrene-alkyd resin, a soya-alkyl resin, polyvinyl chloride, polyvinylidene chloride, polyacrylonitrile, polyacrylic acid, polyacrylate, polymethacrylate, a styrene polymer, an alkyd resin, polyamide, polyurethane, polyester, polysulfone, polyether, and a mixture of the foregoing materials, with polyvinyl butyral or polyvinyl alcohol being preferred in the present invention.

In the charge generating layer composition of the present invention as described above, the amount of the charge generating material is in the range of 55-85% by weight based on the solid content of the charge generating layer composition. The amount of the binder is in the range of 15-45% by weight based on the solid content of the charge generating layer composition. If the amount of the charge generating material exceeds the above range, the ability to generate charges can degrade. If the amount of the binder is less than 15% by weight, the adhesion of the charge generating layer to the charge transport layer can decrease. If the amount of the binder exceeds 45% by weight, the ability to generate carriers in the charge generating layer can degrade due to a relative reduction in the amount of the charge generating material.

A method of manufacturing an organophotoreceptor using the above-described charge generating composition according to the present invention is described below. Initially, a charge transport layer composition is coated on a conductive support and dried to form a charge transport layer. The charge transport layer composition includes a charge transport material, a binder, and an organic solvent. Any material capable of transporting charges can be used as the charge transport material without limitations. An example of the charge transport material is a hydrazone compound. The amount of each of the charge transport material and the binder is in the range of 35-65% by weight based on the solid content of the charge transport layer.

The binder is capable of dissolving or dispersing the charge transport material. Generally, a polycarbonate polymer is used as the binder. Examples of the organic solvent include tetrahydrofuran, methylenechloride, chloroform, dichloroethane, trichloroethane, and chlorobenzene. The amount of the organic solvent is in the range of 70-90% by weight based on the weight of the charge transport layer composition.

To prepare the charge generating layer composition, a binder for the charge generating layer composition as described above is dissolved in an alcoholic solvent, an acetate solvent, or a mixture of these solvents. A charge generating material as described above is added into the mixture and is subjected to milling. Next, an alcoholic solvent, an acetate solvent, or a mixture of alcoholic and acetate solvents is added to the milled product and mixed together, resulting in the charge generating layer composition.

Next, the charge generating layer composition is coated on the charge transport layer and dried to form a charge generating layer, forming a dual-layered positively-charged organophotoreceptor according to the present invention. Any coating technique can be applied to the charge generating layer formation without limitations. However, when a conductive support is shaped like a drum, a ring coating method, a dip coating method, or a spray coating method is preferred.

In the organophotoreceptor according to the present invention, in an embodiment the charge generating layer has a thickness of 0.2-1.0 μm, the charge transport layer has a thickness of 5-20 μm, and the conductive support has a thickness of 0.5-2 mm.

The organophotoreceptor according to the present invention can further include an additional layer, such as a charge blocking layer, an overcoat layer, etc., which are widely known. The charge blocking layer is formed between the conductive support and the charge transport layer to enhance the adhesion and to block electrons from entering into the conductive support. The overcoat layer protects the charge generating layer by being formed thereon.

The dual-layered positively-charged organophotoreceptor is useful in electrophotography using a dry or liquid toner. Especially when a liquid toner is used, the dual-layered positively-charged organophotoreceptor can output high-resolution images by applying low-image fixing energy.

Hereinafter, the present invention will be described in greater detail with reference to the following examples. The following examples are for illustrative purposes and are not intended to limit the scope of the invention.

### EXAMPLE 1

0.84 g polyvinyl butyral (BX-1, SEKISUI CO., Japan) was dissolved in 17.2 g ethanol, and 1.96 g titanyloxy phthalocyanine (ELA 7051, H. W. SANDS CO.) was added to the solution and mixed.

The resulting mixture was milled for 1 hour. 4.29 g of the milled dispersion was diluted with 10.1 g butylacetate and 0.63 g ethanol to prepare a charge generating layer composition.

2 g HCTM 1(SAMSUNG ELECTRONICS, Korea), a hydrazone compound for the charge transport, and 2 g polycarbonate (PCZ200, MITSUBISHI CHEMICAL CO., Japan) were dissolved in 16 g tetrahydrofuran (THF) and filtered through a filter having a 1-μm pore size. The filtered solution was coated on an aluminium drum using a ring coating apparatus at 300 mm/min to form a charge transport layer.

Next, the charge generating layer composition prepared above was filtered through a filter having a 5-μm pore size and coated on the charge transport layer using the ring coating apparatus at 200 mm/min to form a charge generating layer having a thickness of about 0.3-μm.

### EXAMPLE 2

An organophotoreceptor was formed in the same manner as in example 1, except that 4.29 g of the milled dispersion was diluted with 7.2 g butylacetate and 3.51 g ethanol in the preparation of the charge generating layer composition.

### EXAMPLE 3

An organophotoreceptor was formed in the same manner as in example 1, except that 17.2 g isopropyl alcohol/butanol (9:1) cosolvent was used for milling in the preparation of the charge generating layer composition, and 4.29 g of the milled dispersion was diluted with 7.2 g butyl acetate and 3.51 g isopropyl alcohol/butanol (9:1) cosolvent.

### COMPARATIVE EXAMPLE 1

An organophotoreceptor was formed in the same manner as in example 1, except that 4.29 g of the milled dispersion was diluted with 10.71 g ethanol in the preparation of the charge generating layer composition.

### COMPARATIVE EXAMPLE 2

An organophotoreceptor was formed in the same manner as in example 1, except that 17.2 g ethyl acetate was used as a milling solvent in the preparation of the charge generating layer composition, and 4.29 g of the milled dispersion was diluted with 10.73 g ethyl acetate.

The coating status of the charge transport layer in the organophotoreceptor, and the electrostatic properties of the organophotoreceptor were evaluated as follows, using the organophotoreceptors prepared in examples 1 through 3 and Comparative Examples 1 and 2. The results are shown in Table 1.

1) Coating Status

The coating status of the charge transport layer and the charge generating layer were visually evaluated.

2) Charging Potential

The charging potential was measured using a QEA-PDT 2000 machine by applying a voltage of 8 kV.

3) Exposure Potential

The exposure potential was measured by applying an exposure energy of 1 μJ/cm² using a QEA-PDT 2000 machine.

TABLE 1

| | | | | Compa- | |
|---|---|---|---|---|---|
| | | | | rative | |
| Evaluated | | | | Exam- | Comparative |
| property | Example 1 | Example 2 | Example 3 | ple 1 | Example 2 |
| Coating | Good | Good | Good | Good | Defects in |
| status | | | | | the charge |
| | | | | | transport lay- |
| | | | | | er/ rough |
| | | | | | surface |
| Charging | 500 500 | 500 | 510 | — | |
| potential (V) | | | | | |
| Exposure | 42 | 84 | 52 | 134 | — |
| potential (V) | | | | | |

As is apparent from Table 1, the overall coating status of the photoreceptor, including the charge generating layer and the charge transport layer, was good for the organophotoreceptors manufactured in examples 1, 2, and 3, but the organophotoreceptor of Comparative Example 2 was poor with respect to the coating property.

With the use of a proper co-solvent composition of the charge generating layer composition in the organoreceptors of Examples 1, 2 and 3, the lower exposure potential was obtained compared with the organophotoreceptor of Comparative Example 1, which has a well-defined interface. As a result, due to the increase in the quantity of surface charges near the organophotoreceptor, more toner particles can be applied during development, which is more effective in electrophotography that utilizes liquid toner.

The present invention provides the following effects. First, a positively-charged organophotoreceptor having a dual-layered structure can be manufactured using the charge generating layer composition according to the present invention. Second, control of the electrostatic properties of the organophotoreceptor, such as the charging potential, the exposure potential, etc., is facilitated by adjusting the thickness of the charge transport layer and the charge generating layer. Third, since an interface is well-defined between the charge transport layer and the charge generating layer, injection of charges from the charge generating layer to the charge transport layer is facilitated, and the surface potential (exposure potential) in an exposure area can be reduced to a desired level. According to the present invention, the amount of charges near the surface of the organophotoreceptor increases, so that more toner particles can be applied during development, which is more effective in electrophotography using liquid toner.

The present invention may be utilized in a organophotoreceptor cartridge, a organophotoreceptor drum, or in an image forming apparatus. The organophotoreceptor cartridge typically comprises a positively-charged electrophotographic organophotoreceptor and at least one of a charging device that charges the positively-charged electrophotographic organophotoreceptor, a developing device which develops an electrostatic latent image formed on the positively-charged electrophotographic organophotoreceptor, and a cleaning device which cleans a surface of the positively-charged electrophotographic organophotoreceptor. The organophotoreceptor cartridge is capable of being attached to and detached from the image forming apparatus, and the positively-charged electrophotographic organophotoreceptor is described more fully above. The organophotoreceptor drum for an image forming apparatus, generally includes a drum that is attachable to and detachable from the image forming apparatus and that includes a positively-charged electrophotographic organophotoreceptor installed thereon, wherein the positively-charged electrophotographic organophotoreceptor is described more fully above. Generally, the image forming apparatus includes a photoreceptor unit, a charging device which charges the photoreceptor unit, an imagewise light irradiating device which irradiates the charged photoreceptor unit with imagewise light to form an electrostatic latent image on the photoreceptor unit, a developing device which develops the electrostatic latent image with a toner to form a toner image on the photoreceptor unit, and a transfer device which transfers the toner image onto a receiving material, wherein the photoreceptor unit comprises a positively-charged electrophotographic organophotoreceptor as described in greater detail above.

While the present invention has been particularly shown and described with reference to embodiments thereof, it will be understood by those of ordinary skill in the art that various changes in form and details may be made therein without departing from the spirit and scope of the present invention as defined by the following claims.

What is claimed is:

1. A composition for a charge generating layer of an electrophotographic, positively-charged organophotoreceptor in which a charge transport layer and the charge generating layer are sequentially coated on a conductive support, the composition comprising:
a charge generating material;
a binder; and
an organic solvent containing an alcoholic solvent and an acetate solvent in a ratio from 1:9 to 5:5 by weight.

2. The composition of claim 1, wherein the alcoholic solvent is at least one selected from the group consisting of ethanol, isopropyl alcohol, n-butanol, methanol, 1-methoxy-2-propanol, diacetone alcohol, isobutyl alcohol, and t-butyl alcohol, the acetate solvent is at least one selected from the group consisting of ethyl acetate, butyl acetate, isopropyl acetate, isobutyl acetate, and sec-butyl acetate, and the amount of the organic solvent is in the range of approximately 90-99% by weight based on the weight of the composition for the charge generating layer.

3. The composition of claim 1, wherein the charge generating material is at least one selected from the group consisting of titanyloxy phthalocyanine, metal-free phthalocyanine, titanium phthalocyanine, copper phthalocyanine, and hydroxygallium phthalocyanine, and the amount of the charge generating material is in the range of 55-85% by weight based on the solid content of the composition for the charge generating layer.

4. The composition of claim 1, wherein the binder is one of polyvinyl butyral and polyvinyl alcohol, and the amount of the binder is in the range of 15-45% by weight based on the solid content of the composition for the charge generating layer.

5. A positively-charged electrophotographic organophotoreceptor comprising:
a conductive support;
a charge transport layer formed on the conductive support; and
a charge generating layer formed by coating the charge generating layer composition of claim 1 on the charge transport layer and drying the coated charge generating layer composition.

6. The organophotoreceptor of claim 5, wherein the organophotoreceptor is located in a photocopy machine that uses one of a dry toner and a liquid toner.

7. The organophotoreceptor of claim 5, wherein the alcoholic solvent in the charge generating layer composition is at least one selected from the group consisting of ethanol, isopropyl alcohol, n-butanol, methanol, 1-methoxy-2-propanol, diacetone alcohol, isobutyl alcohol, and t-butyl alcohol, the acetate solvent is at least one selected from the group consisting of ethyl acetate, butyl acetate, isopropyl acetate, isobutyl acetate, and sec-butyl acetate, and the amount of the organic solvent is in the range of about 90-99% by weight based on the weight of the composition for the charge generating layer.

8. The organophotoreceptor of claim 5, wherein the charge generating material in the charge generating layer composition is titanyloxy phthalocyanine, metal-free phthalocyanine, titanium phthalocyanine, copper phthalocyanine, or hydroxygallium phthalocyanine, and the amount of the charge generating material is in the range of 55-85% by weight based on the solid content of the composition for the charge generating layer.

9. The organophotoreceptor of claim 5, wherein the binder in the charge generating layer composition is polyvinyl butyral or polyvinyl alcohol, and the amount of the binder is in the range of 15-45% by weight based on the solid content of the composition of the charge generating layer.

10. A method of manufacturing a positively-charged electrophotographic organophotoreceptor, comprising:
forming a charge transport layer on a conductive support;
dissolving a binder in an organic solvent selected from the group consisting of an alcoholic solvent, an acetate solvent, and a mixture of the alcoholic and acetate solvents, followed by the addition of a charge generating material, milling, dilution of the milled product with an alcoholic solvent, an acetate solvent, or a mixture of the alcoholic and acetate solvents, and mixing, to form a charge generating layer composition; and
coating the charge generating layer composition on the charge transport layer and drying the charge generating layer composition to form a charge generating layer.

11. The method of claim 10, wherein the coating is performed by ring coating, dip coating, or spray coating.

12. An organophotoreceptor cartridge of an image forming apparatus, having a positively-charged electrophotographic organophotoreceptor installed therein, the organophotoreceptor cartridge comprising:
a positively-charged electrophotographic organophotoreceptor; and
at least one of a charging device that charges the positively-charged electrophotographic organophotoreceptor, a developing device which develops an electrostatic latent image formed on the positively-charged electrophotographic organophotoreceptor, and a cleaning device which cleans a surface of the positively-charged electrophotographic organophotoreceptor,
wherein the organophotoreceptor cartridge is capable of being attached to and detached from the image forming apparatus, and
wherein the positively-charged electrophotographic organophotoreceptor comprises:
a conductive support;
a charge transport layer formed on the conductive support; and
a charge generating layer formed by coating a charge generating layer composition on the charge transport layer and drying the coated charge generating layer composition, wherein the charge generating layer composition comprises:
a charge generating material;
a binder; and
an organic solvent containing an alcoholic solvent and an acetate solvent in a ratio from 1:9 to 5:5 by weight.

13. The organophotoreceptor cartridge of claim 12, wherein the image forming apparatus utilizes one of a dry toner and a liquid toner.

14. The organophotoreceptor cartridge of claim 12, wherein the alcoholic solvent in the charge generating layer composition is at least one selected from the group consisting of ethanol, isopropyl alcohol, n-butanol, methanol, 1-methoxy-2-propanol, diacetone alcohol, isobutyl alcohol, and t-butyl alcohol, the acetate solvent is at least one selected from the group consisting of ethyl acetate, butyl acetate, isopropyl acetate, isobutyl acetate, and sec-butyl acetate, and the amount of the organic solvent is in the range of about 90-99% by weight based on the weight of the charge generating layer composition.

15. The organophotoreceptor cartridge of claim 12, wherein the charge generating material in the charge generating layer composition is at least one selected from the group consisting of titanyloxy phthalocyanine, metal-free phthalocyanine, titanium phthalocyanine, copper phthalocyanine, and hydroxygallium phthalocyanine, and the amount of the charge generating material is in the range of 55-85% by weight based on the solid content of the charge generating layer composition.

16. The organophotoreceptor cartridge of claim 12, wherein the binder in the charge generating layer composition is one of polyvinyl butyral and polyvinyl alcohol, and the amount of the binder is in the range of 15-45% by weight based on the solid content of the charge generating layer composition.

17. An organophotoreceptor drum for an image forming apparatus, comprising:
a drum having a positively-charged electrophotographic organophotoreceptor installed thereon, wherein the positively-charged electrophotographic organophotoreceptor comprises:
a conductive support coated on the drum;
a charge transport layer formed on the conductive support; and
a charge generating layer formed by coating a charge generating layer composition on the charge transport layer and drying the coated charge generating layer composition,
wherein the drum is attachable to and detachable from the image forming apparatus, and
wherein the charge generating layer composition comprises:
a charge generating material;
a binder; and
an organic solvent containing an alcoholic solvent and an acetate solvent in a ratio from 1:9 to 5:5 by weight.

18. The organophotoreceptor drum of claim 17, wherein the image forming apparatus utilizes one of a dry toner and a liquid toner.

19. The organophotoreceptor drum of claim 17, wherein the alcoholic solvent in the charge generating layer composition is at least one selected from the group consisting of ethanol, isopropyl alcohol, n-butanol, methanol, 1-methoxy-2-propanol, diacetone alcohol, isobutyl alcohol, and t-butyl alcohol, the acetate solvent is at least one selected from the group consisting of ethyl acetate, butyl acetate, isopropyl acetate, isobutyl acetate, and sec-butyl acetate, and the amount of the organic solvent is in the range of about 90-99% by weight based on the weight of the charge generating layer composition.

20. The organophotoreceptor drum of claim 17, wherein the charge generating material in the charge generating layer composition is at least one selected from the group consisting of titanyloxy phthalocyanine, metal-free phthalocyanine, titanium phthalocyanine, copper phthalocyanine, and hydroxygallium phthalocyanine, and the amount of the charge generating material is in the range of 55-85% by weight based on the solid content of the charge generating layer composition.

21. The organophotoreceptor drum of claim 17, wherein the binder in the charge generating layer composition is one of polyvinyl butyral and polyvinyl alcohol, and the amount of the binder is in the range of 15-45% by weight based on the solid content of the charge generating layer composition.

22. An image forming apparatus comprising:
a photoreceptor unit;
a charging device which charges the photoreceptor;
an imagewise light irradiating device which irradiates the charged photoreceptor unit with imagewise light to form an electrostatic latent image on the photoreceptor unit;
a developing device which develops the electrostatic latent image with a toner to form a toner image on the photoreceptor unit; and
a transfer device which transfers the toner image onto a receiving material,
wherein the photoreceptor unit comprises a positively-charged electrophotographic organophotoreceptor comprising:
a conductive support;
a charge transport layer formed on the conductive support; and
a charge generating layer formed by coating a charge generating layer composition on the charge transport layer and drying the coated charge generating layer composition, wherein the charge generating layer composition comprises:
a charge generating material;
a binder; and
an organic solvent containing an alcoholic solvent and an acetate solvent in a ratio from 1:9 to 5:5 by weight.

23. The image forming apparatus of claim 22, wherein the image forming apparatus utilizes one of a dry toner and a liquid toner.

24. The image forming apparatus of claim 22, wherein the alcoholic solvent in the charge generating layer composition is at least one selected from the group consisting of ethanol, isopropyl alcohol, n-butanol, methanol, 1-methoxy-2-propanol, diacetone alcohol, isobutyl alcohol, and t-butyl alcohol, the acetate solvent is at least one selected from the group consisting of ethyl acetate, butyl acetate, isopropyl acetate, isobutyl acetate, and sec-butyl acetate, and the amount of the organic solvent is in the range of about 90-99% by weight based on the weight of the charge generating layer composition.

25. The image forming apparatus of claim 22, wherein the charge generating material in the charge generating layer composition is at least one selected from the group consisting of titanyloxy phthalocyanine, metal-free phthalocyanine, titanium phthalocyanine, copper phthalocyanine, and hydroxygallium phthalocyanine, and the amount of the charge generating material is in the range of 55-85% by weight based on the solid content of the charge generating layer composition.

26. The image forming apparatus of claim 22, wherein the binder in the charge generating layer composition is one of polyvinyl butyral and polyvinyl alcohol, and the amount of the binder is in the range of 15-45% by weight based on the solid content of the charge generating layer composition.
